(19) United States
(12) Patent Application Publication
(10) Pub. No.: US 2006/0020370 A1
(43) Pub. Date: Jan. 26, 2006

(54) System and method for confining a robot

(76) Inventor: Shai Abramson, Har-Halutz (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/186,250

(22) Filed: Jul. 21, 2005

Related U.S. Application Data
(60) Provisional application No. 60/590,233, filed on Jul. 22, 2004.

(51) Int. Cl. G06F 19/00

(52) U.S. Cl. 700/245; 700/258

(57) ABSTRACT

A robot is confined to a bounded area by placement of a retroreflective marker, defining a boundary, and a detector on the robot. The detector sends a signal, that if reflected off of the marker, toward the robot, and detected by a receiver, will signal the control system of the robot, such that the robot changes its travel path and remains confined within the bounded area.

### CROSS REFERENCES TO RELATED APPLICATIONS

This application is related to and claims priority from U.S. Provisional Patent Application Ser. No. 60/590,233, entitled: System And Method For Confining A Robot, filed Jul. 22, 2004, the disclosure of which is incorporated by reference in its entirety herein.

### FIELD OF THE INVENTION

The present invention pertains to autonomous robots. In particular, the invention pertains to autonomous robots and systems including these robots, along with methods, for maintaining these robots in operation in confined areas.

### BACKGROUND OF THE INVENTION

Autonomous machines and devices, such as autonomous robots, have been designed for performing various industrial and domestic functions. These domestic functions include vacuum cleaning, lawn mowing, floor sweeping and maintenance. By extending robots to these domestic functions, the person or user employing these robots has increased free or leisure time, as they do not have to expend the time required to perform the aforementioned tasks manually.

These autonomous robots typically operate in accordance with various computer programs that are part of the operating systems. These programs provide the paths, along which the autonomous robot travels, also known as the footprint. However, there are times when it is desirable to restrict the travel of these autonomous robots to a confined area. For example, with a robotic vacuum cleaner, it is desirable to limit travel of the vacuum cleaner to confine it to a portion of a room where vacuuming is desired, such that it will not travel to another portion of the room where vacuuming is not desired.

An autonomous robot is disclosed in commonly owned U.S. Patent Application Publication (Published U.S. Patent Application) No. US 2003/0060928 A1 (20030060928 A1), entitled: Robotic Vacuum Cleaner (filed on Dec. 4, 2001 and published Mar. 27, 2003), and commonly owned U.S. Patent Application Publication (Published U.S. Patent Application) No. US 2003/0120389 A1 (20030120389 A1), entitled: Robotic Vacuum Cleaner (filed on Feb. 7, 2003 and published on Jun. 26, 2003), both documents (applications) incorporated by reference in their entirety herein. In the aforementioned U.S. Patent Application Publications, the autonomous robot performs functions such as those of a vacuum cleaner, whose movement is confined to a specific portion of a room by a transmitter, placed at a location in the room, that forms a “virtual wall.” This virtual wall serves as a boundary, to keep the autonomous robot within a desired area.

### SUMMARY OF THE INVENTION

The present invention provides an autonomous or mobile robot and system that utilizes this robot, for confining the travel (and movement) of the robot to a desired area. The invention utilizes an autonomous robot that includes a detector for detecting a marker that defines a boundary, and with the boundary detected, keeping the autonomous robot within the area defined by the boundary.

An embodiment of the invention is directed to an autonomous robot for moving over a surface of an area. The robot includes a drive (or movement) system, and a detector coupled to the drive system. The detector is constructed for detecting a retroreflected signal for operating the autonomous robot in a predefined area. The detector typically includes a transmitter and a receiver, the transmitter for sending at least one signal, that if retroreflected (reflected in a direction toward the robot), off of a marker (that typically defines a boundary for the robot), is detectable by the receiver. If the retroreflected signal is detected, the drive system of the robot is signaled to change the travel path of the robot, to keep the robot confined in the predefined area.

Another embodiment of the invention is directed to a system for limiting coverage of an apparatus, for example, an autonomous robot, to a portion of an area. The system includes an apparatus (e.g., an autonomous robot) for moving over an area, the apparatus including a drive system, and a detector coupled to the drive system. The detector can detect a retroreflected signal, in order to operate the autonomous robot in a predefined area. The system also includes a marker of a retroreflective (retro-reflective) material for retroreflecting signals that contact it. These signals are typically sent from a transmitter of the apparatus. The detector typically includes a transmitter and a receiver, the transmitter for sending at least one signal, that if retroreflected, is detectable by the receiver. If the retroreflected signal is detected, the drive system of the robot is signaled to change the travel path of the robot, to keep the robot confined in the specific portion of the area.

Another embodiment of the invention is directed to autonomous robot for moving over an area. The robot includes, a control system, including a drive system, and at least one detector electronically coupled (linked) to the control system. The at least one detector is such that it sends one or more signals, typically at predetermined intervals at least one signal and detects the signal if the signal is reflected toward the robot, for causing the drive system to move the robot in a predefined area, while the robot remains confined in the predefined area.

Another embodiment of the invention is directed to a system for confining an autonomous machine, such as a robot, for example, a robot carrying a payload for vacuum cleaning or other function, to a bounded area. The system includes a marker and an autonomous machine. The marker includes at least a portion of a retroreflective material, such that the marker defines at least a portion of a boundary for the bounded area. The autonomous machine is for moving over the bounded area. It includes, a drive system for moving the autonomous machine along a surface, and, at least one detector in electronic communication with the drive system. The at least one detector sends at least one signal and detects the at least one signal if the at least one signal is reflected toward the autonomous machine, off of the marker, and, if the at least one signal is detected by the detector, the drive system moves the autonomous machine, such that the autonomous machine remains in the bounded area.

Another embodiment of the invention is directed to a method for confining a robot, autonomous machine or the like, to a bounded area. The method includes placing a marker, including at least a portion of a retroreflective material, such that the marker defines at least a portion of a boundary for the bounded area, and, operating a robot in the bounded area. Operating the robot includes, sending at least one signal from the robot, monitoring a receiver for detecting the at least one signal that has been reflected off of the marker, and, if the at least one signal has been detected, changing the path of travel for the robot so that the robot remains in the bounded area.

Another embodiment is also directed to a method for confining a robot, autonomous machine, or the like, to a bounded area. The method includes, placing a marker having at least a portion of a retroreflective material such that the marker defines at least a portion of a boundary for the bounded area, and, operating a robot in the bounded area. Operating the robot includes, sending at least one signal from the robot, and, if the at least one signal has been detected by a reflection off of the marker, changing the path of travel for the robot so that the robot remains in the bounded area.

### BRIEF DESCRIPTION OF THE DRAWINGS

Attention is now directed to the drawing figures, where like numbers or characters indicate corresponding or like components. In the drawings:

FIG. 1 is a diagram of an exemplary operation of an embodiment of the invention;

FIGS. 2 and 3 are diagrams of a system in accordance with an embodiment of the invention in exemplary operations;

FIG. 4 is a schematic diagram for the control system of a robot or other autonomous machine that performs operations in accordance with embodiments of the invention;

FIG. 5 is a diagram of an apparatus of a system in accordance with an embodiment of the invention;

FIG. 6 is a diagram of a second exemplary operation of an embodiment of the invention; and,

FIG. 7 is a diagram of a third exemplary operation of an embodiment of the invention.

### DETAILED DESCRIPTION

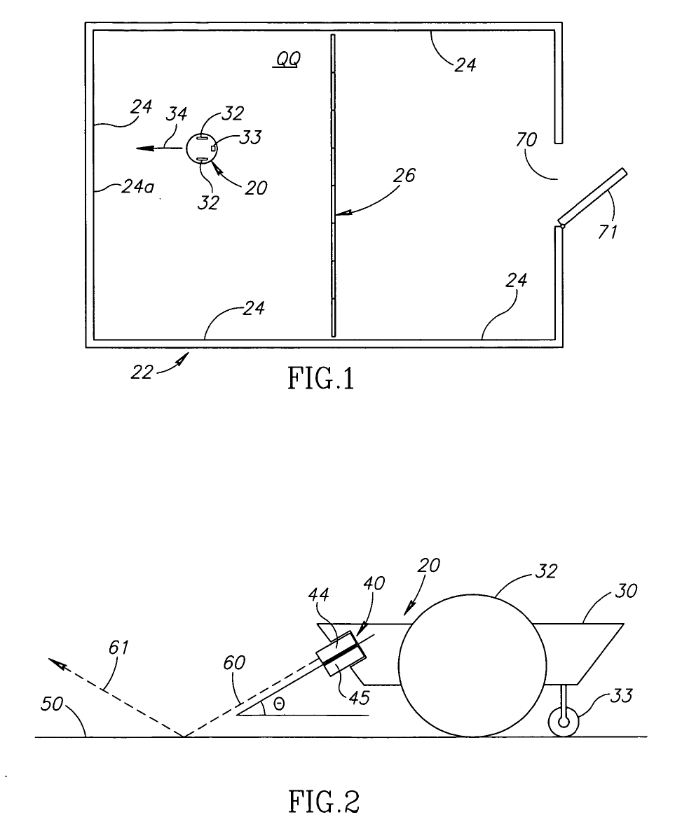

FIG. 1 shows the system of the present invention confining the path of travel of an autonomous or mobile robot 20 (also known as the robot). The autonomous robot 20 may be a robot that performs vacuum and/or surface cleaning. For example, the autonomous robot 20 may be a robotic vacuum cleaner, such as that disclosed in U.S. patent application Publication No. US 2003/0060928 A1 (20030060928 A1), entitled: Robotic Vacuum Cleaner (filed on Dec. 4, 2001 and published Mar. 27, 2003), and U.S. patent application Publication No. US 2003/0120389 A1 (20030120389 A1), entitled: Robotic Vacuum Cleaner (filed on Feb. 7, 2003 and published on Jun. 26, 2003), both documents (applications) incorporated by reference in their entirety herein.

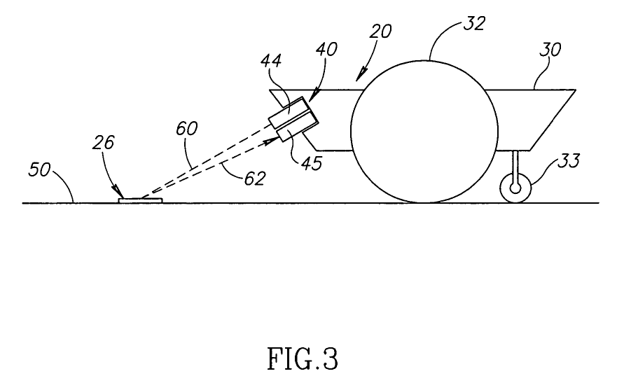

The autonomous robot 20 has its travel path or footprint confined to a portion QQ of a room 22, bounded by the walls 24 of the room 22 and a marker 26 (defining a desired working area for the autonomous robot 20). The robot 20, for example, has a vacuum cleaner payload, as disclosed in U.S. patent application Publication Nos. US 2003/0060928 A1 (20030060928 A1) and US 2003/0120389 A1 (20030120389 A1), and includes oppositely disposed drive wheels 32 and a rear support wheel 33, also as disclosed in U.S. patent application Publication Nos. US 2003/0060928 A1 (20030060928 A1) and US 2003/0120389 A1 (20030120389 A1) (as also shown in FIGS. 2 and 3). The robot 20, as shown in FIG. 1, is operating such that its normal forward movement is in the direction toward the wall 24a (in the direction of the arrow 34).

Turning also to FIGS. 2 and 3, the robot 20 includes a body 30 (representative, for example, of the body of the robot disclosed in U.S. patent application Publication Nos. US 2003/0060928 A1 (20030060928 A1) and US 2003/0120389 A1 (20030120389 A1)), in which one or more detectors 40 (also known as sensors) (only one shown for illustration purposes, as all detectors 40 function similarly) are mounted, typically by attachment to the body 30, and typically along the lower periphery of the body 30 (the lower periphery in accordance with a typical orientation of the robot 20, as shown, for example, in FIGS. 2 and 3).

An exemplary arrangement of detectors (sensors) 40 includes one detector mounted at the front of the robot 20 (at the end of the robot 20 opposite the end of the robot 20 where the support wheel 33 is positioned), and at the sides, proximate to the drive wheels 32. Additional detectors (sensors) 40 may also be added to this arrangement. Multiple other arrangements of one or more detectors (sensors) 40 are also permissible. Moreover, should the robot have only a single detector (sensor) 40, this detector (sensor) 40 would be at the front of the robot 20 (at the end of the robot 20 opposite the end of the robot 20 where the support wheel 33 is positioned).

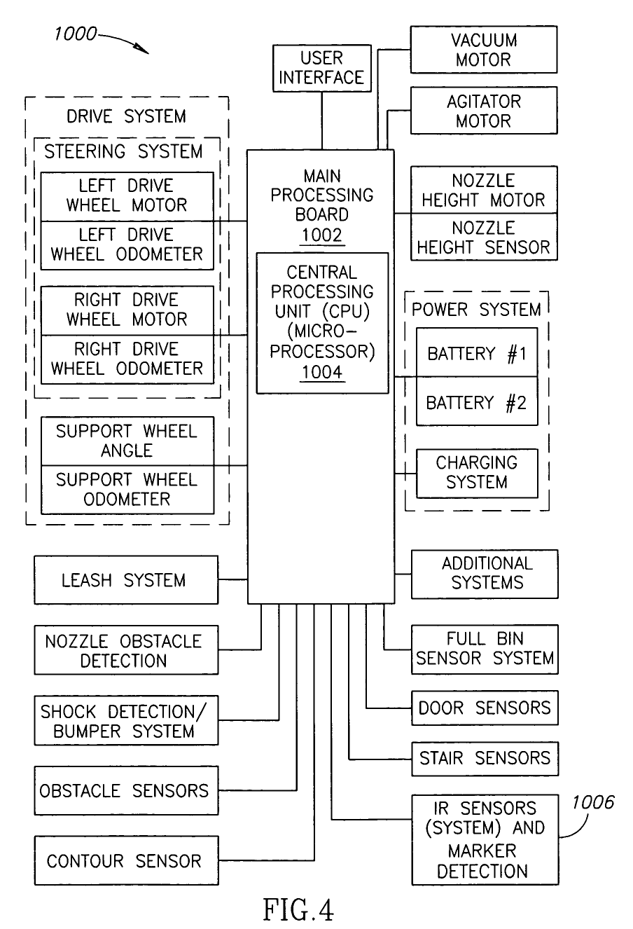

The detectors 40 are electronically coupled or linked (by wired, wireless or combinations of wired and wireless links) to the control system 1000 (FIG. 4, and detailed below) of the robot 20. The control system 1000 is also coupled (electronically, by wired, wireless, or combinations of wired and wireless links) to the drive (movement) system of the robot 20, and can control movement of the robot 20 in accordance with the signal(s) received from one or more of the detector(s) 40.

The detector 40, may be, for example, a transceiver, for sending and receiving single or multiple signals, in the form of light, such as infrared (IR) radiation, including IR light or IR radiant energy, other light wavelengths and other radiant energy, sound waves and the like. The detector 40 is typically formed of a transmitter 44 and a receiver 45. The transmitter 44 and receiver 45, are typically positioned parallel to each other and at an angle Θ of approximately 30° to approximately 80° with respect to the horizontal (for example, the floor surface 50). For example, the angle E) may be approximately 35° (FIG. 2) with respect to the horizontal. The transmitter 44 is typically a transmitter of infrared (IR) light, while the receiver 45 is typically an IR light receiver. Alternately, the transmitter 44 and receiver 45 may be modified for other light wavelengths as desired, as well as sound, other forms of waves or energy, other forms of signals, and the like.

Turning also to FIG. 4, there is shown a schematic diagram of the control system 1000 for the robot 20, to which the one or more detectors 40 (sensors) are electronically coupled (linked). The control system 1000 is similar the control system for the robot disclosed in U.S. patent application Publication Nos. US 2003/0060928 A1 (20030060928 A1) and US 2003/0120389 A1 (20030120389 A1). The control system 1000 includes a main board 1002 with a central processing unit (CPU) 1004, that includes a processor, such as a microprocessor, and includes circuitry (electronic components and the like) for marker (boundary or boundary marker) detection 1006, associated with (and linked to) the detectors (or sensors) 40. As the detectors or sensors 40 are electronically coupled (linked) to the main processing board 1002 and the CPU 1004 thereon, via the associated circuitry as represented by box 1006, the transmitted signal (or signals) from the transmitter 44 may be controlled. When a signal (or signals) are received in the receiver 45, as the result of a retroreflection (reflection of the signal toward the robot 20) of the emitted signal (or signals) off of the marker 26 (as detailed below), the processor 1004 receives a signal (or signals) indicative of the received (retro-reflected or reflected in the direction toward the robot 20) signal (or signals). The CPU 1004 signals the drive system, that causes the drive (movement) system to change the course of the autonomous robot 20, typically so that the robot 20 stays within the desired area, for example, a designated work area.

The detector(s) (sensor(s)) 40, either alone coupled with other obstacle sensors, object sensors, contour sensors, and the like, as described in U.S. patent application Publication Nos. US 2003/0060928 A1 (20030060928 A1) and US 2003/0120389 A1 (20030120389 A1), and coupled with the CPU 1004, typically define a navigation system for the robot 20. Like the robot disclosed in U.S. patent application Publication Nos. US 2003/0060928 A1 (20030060928 A1) and US 2003/0120389 A1 (20030120389 A1), the robot 20 may utilize various scanning patterns, typically programmed into or stored in the control system 1000. These scanning patterns define the travel path of footprint for the robot 20, for moving within the work area (the confined area or area bounded by the marker(s) 26 and typically, coupled with other existing confinements of a room, such as walls 24). The robot 20, with its with obstacle sensors, object sensors, contour sensors and other sensors, as described above, all electronically linked to the CPU 1004, for detecting other confinements, such as walls and the like, is such that if any of these other confinements are also detected (in addition to the marker(s) 26), a signal is sent from the requisite sensor to the CPU 1004. The CPU 104 will signal the drive system to change the travel path (footprint) for the robot 20 in the work area, as disclosed in U.S. patent application Publication Nos. US 2003/0060928 A1 (20030060928 A1) and US 2003/0120389 A1 (20030120389 A1).

The marker 26 is typically of a retroreflective material. This retroreflective material is typically formed of wide angle, exposed retroreflective lenses, bonded to a rubber-based pressure-sensitive adhesive. For example, the marker 26 may be of Scotchlite Tm reflective material, from 3M™ Corporation of St. Paul, Minn. The marker 26 may be in the form of a sticker, tape (or tape roll), or decal, typically with a peel off release member, inert to the adhesive, in contact with the adhesive side, to keep the adhesive fresh and clean of debris.

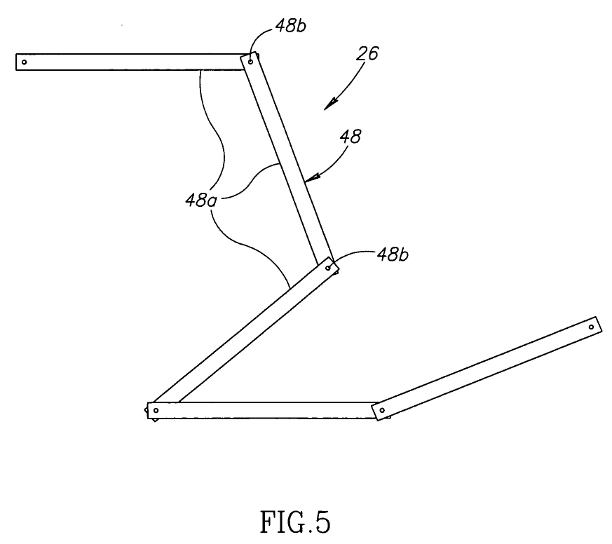

Alternately, the marker 26 may be a non-adhesive sided member, such as, a strip, or a spring-loaded strip, or a rolled-up strip. The marker 26 may also be a multi-segmented strip 48, formed of hinged segments 48a, that pivot at joints 48b, as shown in FIG. 5. The multi-segmented strip 48 may be folded out into orientations such as linear and rounded, and combinations thereof, in accordance with the boundary desired. Segments 48a may be added or removed as desired, depending on the area desired to be marked, so that it may be bounded.

Referring back to FIG. 1, the marker 26 shown is a multi-segmented strip (like the multi-segmented strip 48 of FIG. 5), but may also be one or more pieces of retroreflective tape or the like. In the case of non-adhesive sided markers, they may be attached to the surface (floor) 50 (FIGS. 2 and 3) by additional securement mechanisms, if desired, such as tape, adhesives, mechanical fasteners (nails, tacks, weights), and the like. For example, the marker 26 may be a narrow strip, approximately 1 cm to approximately 3 cm wide.

Operation of the system will now be described with reference to FIGS. 1-4. As the autonomous robot 20 moves along a surface 50, the transmitters 44 of the detectors 40 (sensors) emit signals, for example, infrared (IR) light beams. These signals are typically emitted at intervals, for example, approximately every 10 milliseconds. As shown in FIG. 2, when the emitted (sent) signal (shown by the broken line 60) contacts the surface 50 at a point where marker 26 is not present, the signal will reflect in a direction away from the autonomous robot 20 (shown by the broken line 61). By not receiving any signals from the receiver 45 (as the receiver 45 has not received (detected) any signal or signals transmitted (sent) from the transmitter 44, the control system 1000, through the receiver 45, typically monitoring for receipt of the transmitted (sent) signal or signals)), at the main board 1002, and, in particular, the CPU 1004, of the control system 1000 (FIG. 4), the autonomous robot 20 moves in accordance with its predetermined path of travel (or footprint), as detailed above.

Alternately, as shown in FIG. 3, when the autonomous robot 20 approaches the predetermined boundary, as indicated by the marker 26, the emitted (sent) signal or signals (shown by the broken line 60) contacts the marker 26, and is reflected in a direction toward the autonomous robot 20 (as shown by the broken line 62), a reflection in this direction being a retroreflection. The retroreflected signal (or signals) is/are detected by the receiver 45. The receiver 45 signals the control system 1000 (FIG. 4), that causes the drive (movement) system to change the course of the autonomous robot 20, so that the robot 20 stays within the work area, for example, the area QQ in FIG. 1.

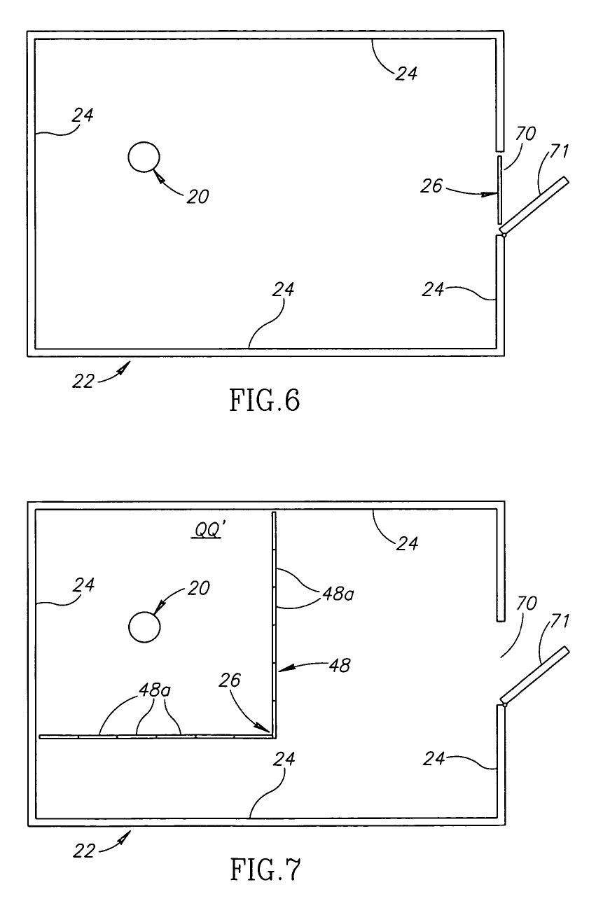

FIG. 6 shows an alternate embodiment of the invention. For example, a marker 26 has been placed at the doorway 70 (proximate to the door 71) of the room 22. The marker 26 is of a length sufficient to be detected by the detector(s) (sensor(s)) 40, such that the robot 20 can not move through the doorway 70. As such, the entire room 22 is the work area, as the autonomous robot 20 remains confined therein.

FIG. 7 shows another alternate embodiment of the invention. For example, the marker 26 is a multi-segmented strip 48 (as shown in FIG. 5 and detailed above). The marker 26 has been folded, to form two boundaries, that along with adjacent walls 24, define a work area QQ′ for the autonomous robot 20. The robot 20 remains confined within this work area QQ′, and does not travel into the remainder of the room 22. Alternately, the marker 26 may be single or multiple pieces of retroreflective tape.

While an autonomous robot or machine that functions as a vacuum cleaner has been shown and described above, this is exemplary only. The above-disclosed subject matter can also be applied with and adapted for other robots or autonomous machines, that perform various tasks, including cleaning, sweeping, polishing, lawn mowing, gardening, earth moving, etc.

While preferred embodiments of the present invention have been described, so as to enable one of skill in the art to practice the present invention, the preceding description is intended to be exemplary only. Moreover, the embodiments and components thereof are exemplary. This description should not be used to limit the scope of the invention, which should be determined by reference to the following claims.

What is claimed is:

1. An autonomous robot comprising:
a control system including a drive system; and
at least one detector in electronic communication with the control system, the at least one detector configured for sending at least one signal and detecting the at least one signal if the at least one signal is reflected toward the robot, for causing the drive system to move the robot in a predefined area.

2. The autonomous robot of claim 1, wherein the at least one detector includes a transmitter and a receiver, the transmitter configured for sending at least one signal that if reflected toward the autonomous robot is detectable by the receiver.

3. The autonomous robot of claim 2, wherein the at least one signal includes infrared (IR) light.

4. The autonomous robot of claim 1, wherein the control system is configured for monitoring receipt of the at least signal by the at least one detector for controlling the movement of the robot.

5. The autonomous robot of claim 2, additionally comprising:
a body;
a plurality of wheels, at least two wheels oppositely disposed with respect to each other and controllable by the control system fro moving the robot over a surface; and
the least one detector is positioned along the periphery of the body at a level proximate to the level of the wheels.

6. The autonomous robot of claim 5, wherein the at least one detector is oriented approximately 30° to approximately 80° with respect to the horizontal.

7. The autonomous robot of claim 6, wherein the at least one detector includes a plurality of detectors.

8. The autonomous robot of claim 1, wherein the robot is configured for performing vacuum cleaning.

9. A system for confining an autonomous machine to a bounded area, comprising:
a marker including at least a portion of a retroreflective material, the marker for defining at least a portion of a boundary for the bounded area; and,
an autonomous machine for moving over the bounded area, the autonomous machine comprising:
a drive system for moving the autonomous machine along a surface; and
at least one detector in electronic communication with the drive system, the at least one detector configured for sending at least one signal and detecting the at least one signal if the at least one signal is reflected toward the autonomous machine, off of the marker, and if the at least one signal is detected by the detector, causing the drive system to move the autonomous machine, such that the autonomous machine remains in the bounded area.

10. The system of claim 9, wherein the autonomous machine includes a robot.

11. The system of claim 10, wherein the robot is configured for vacuum cleaning.

12. The system of claim 10, wherein the marker is a single piece.

13. The system of claim 10, wherein the marker includes a plurality of segments.

14. The system of claim 10, wherein the single piece includes a first side including the at least a portion of the retroreflective material, and a second side including adhesive.

15. The system of claim 13, wherein each segment of the plurality of segments includes a first side including the at least a portion of the retroreflective material, and a second side including adhesive.

16. The system of claim 13, wherein the segments are movably connected together.

17. A method for confining a robot to a bounded area, comprising:
placing a marker including at least a portion of a retroreflective material such that the marker defines at least a portion of a boundary for the bounded area;
operating a robot in the bounded area, the operating comprising:
sending at least one signal from the robot;
monitoring a receiver for detecting the at least one signal that has been reflected off of the marker; and,
if the at least one signal has been detected, changing the path of travel for the robot so that the robot remains in the bounded area.

18. The method of claim 17, wherein the at least one signal that has been reflected off of the marker, is retroreflected off of the marker.

19. The method of claim 17, wherein operating the robot additionally comprises vacuum cleaning.

20. A method for confining a robot to a bounded area, comprising:
placing a marker including at least a portion of a retroreflective material such that the marker defines at least a portion of a boundary for the bounded area;
operating a robot in the bounded area, the operating comprising:
sending at least one signal from the robot; and,
if the at least one signal has been detected by a reflection off of the marker, changing the path of travel for the robot so that the robot remains in the bounded area.

21. The method of claim 20, wherein the at least one signal that has been reflected off of the marker, is retroreflected off of the marker.

22. The method of claim 20, wherein operating the robot additionally comprises vacuum cleaning.
